(19) United States
(12) Patent Application Publication
(10) Pub. No.: US 2026/0292508 A1
(43) Pub. Date: Sep. 24, 2026

(54) APPARATUS AND METHOD FOR IDENTIFYING BASE STATION BEHAVIOUR

(71) Applicant: Telefonaktiebolaget LM Ericsson (publ), Stockholm (SE)

(72) Inventors: Jakob STERNBY, Lund (SE); Prajwol Kumar NAKARMI, Solna (SE)

(21) Appl. No.: 19/472,552

(22) PCT Filed: Apr. 4, 2023
(86) PCT No.: PCT/SE2023/050307

§ 371 Date: Oct. 3, 2025

(51) Int. Cl. H04W 12/121; H04B 17/309; H04B 17/318; H04L 41/16; H04W 24/10; H04W 76/20

(52) U.S. Cl. CPC H04W 12/121; H04B 17/328; H04B 17/346; H04L 41/16; H04W 24/10; H04W 76/20

(57) ABSTRACT

A method for identifying anomalous base station behaviour in a communications network comprises generating an ensemble algorithm ML model, performing first training of plural decision trees in the ML model and performing second training of the decision trees such that feature values of diversion nodes are included in feature contributions of anomaly detection nodes. The method further includes processing communications network report data using the ML model, identifying a base station exhibiting anomalous behaviour and generating an alert. A machine learning agent, a communications network, a computer program and a computer-readable storage medium are also disclosed.

### TECHNICAL FIELD

Embodiments described herein relate to a machine learning (ML) agent and method for identifying base station behaviour. A communications network is also disclosed.

### BACKGROUND

Networks, such as 3^{rd} Generation Partnership Project (3GPP) 5^{th} Generation (5G) telecommunications networks, 3GPP 6^{th} Generation (6G) telecommunications networks, Institute of Electrical and Electronics Engineers (IEEE) standard 802.11 compliant networks (which may be referred to as WiFi networks), and so on, may be utilised to provide communication coverage to an environment. In order to provide communication coverage, networks typically utilise a plurality of base stations distributed throughout the environment, wherein the base stations provide network connections for User Equipments (UEs) to the network, and typically also exchange information with one another and with other network components such as core network nodes (CNN).

Base stations in a network are typically deployed across an environment (that is, a physical area, such as all or part of a country) and not directly supervised by an on-site observer; accordingly, anomalous behaviour by a base station may not be immediately detected. Anomalous behaviour in this context can result from, for example, a base station forming part of the telecommunications network developing a fault; this faulty base station may then not handle network traffic correctly or as would be expected. Alternatively, anomalous behaviour may result from the actions of a false base station.

A false base station in this context may be a device owned by a different entity to the legitimate operator or user of the network and posing as a base station in the network. The false base station may be intended to perform active or passive attacks against “true” base stations (that is, base stations forming part of the network) and/or UEs to steal private information relating to users or the network. False base stations may also cause other issues, such as blocking user access to network operator services; this is particularly likely to occur when users connect to the false base stations erroneously believing the false base stations to form part of the network (that is, to be “true” base stations).

One possible means for detecting anomalous base station behaviour would be to have observers (for example, human experts) permanently located at each true base station to monitor the base station behaviour; monitoring in this way would clearly be very time consuming and inefficient. An alternative means for potentially monitoring base station behaviour is through analysis of communications network report data. Obtaining communications network report data, such as Radio Resource Control (RRC) measurements from network components may be supported by existing communication networks. However, detection of anomalous behaviour communications network report data may be a difficult and time-consuming task if performed, for example, by human experts. Detection of false base stations in particular may therefore be challenging; false base stations may be deactivated and removed before their operations are detected by network owners.

### SUMMARY

It is an object of the present disclosure to provide methods, apparatus and computer-readable media which at least partially address one or more of the challenges discussed above. In particular, it is an object of the present disclosure to prevent or minimise the impact of issues arising from faulty or false base station(s) by providing a system for base station behaviour monitoring, with the objective of detecting anomalous base station behaviour.

The present disclosure provides a method for identifying anomalous base station behaviour in a communications network. The method comprises generating an ensemble algorithm ML model comprising a plurality of decision trees, wherein each of the decision trees comprises a root node and a plurality of levels of nodes, each node in a given level being connected to a maximum of two child nodes in a subsequent level. The method further comprises performing first training of each of the plurality of decision trees using a plurality of data instances, such that a first portion of the nodes in each decision tree act as selection nodes that direct a portion of received data instances to each of two child nodes, based on analysis of the feature values of the received data instances, and a second portion of the nodes in each decision tree act as anomaly detection nodes that direct a majority of the received data instances to one of two child nodes, based on analysis of the feature values of the received data instances, where the child node that receives a minority of the received data instances acts as an end node. The method also comprises performing second training of each of the plurality of decision trees. In the second training, a given anomaly detection node in a given decision tree analyses all of the data instances analysed by the given decision tree in the first training, wherein a subset of at least one data instance is directed to the given end node of the given anomaly detection node, the subset directed to the given end node of the given anomaly detection node is analysed by the root node of the given decision tree. Also in the second training, paths of the at least one data instance through the given decision tree are monitored and the diversion nodes at which the at least one data instance from the subset are diverted from the path to the given end node are identified, and feature values of the diversion nodes are included in a feature contribution of the given anomaly detection node. The method further comprises processing communications network report data using the ensemble algorithm ML model, and detecting the presence of anomalous behaviour using the anomaly detection nodes. The method still further comprises identify a base station exhibiting anomalous behaviour using the feature contribution of the anomaly detection nodes, and generating an alert in response to the identification of a base station exhibiting anomalous behaviour.

The present disclosure also provides a ML agent configured to host a ML model, the ML agent comprising processing circuitry and a memory containing instructions executable by the processing circuitry. The ML agent is operable to generate an ensemble algorithm ML model comprising a plurality of decision trees, wherein each of the decision trees comprises a root node and a plurality of levels of nodes, each node in a given level being connected to a maximum of two child nodes in a subsequent level. The ML agent is further operable to perform first training of each of the plurality of decision trees using a plurality of data instances, such that a first portion of the nodes in each decision tree act as selection nodes that are configured to direct a portion of received data instances to each of two child nodes, based on analysis of the feature values of the received data instances, and a second portion of the nodes in each decision tree act as anomaly detection nodes that are configured to direct a majority of the received data instances to one of two child nodes, based on analysis of the feature values of the received data instances, where the child node that receives a minority of the received data instances is configured to act as an end node. The ML agent is further operable to perform second training of each of the plurality of decision trees. In the second training, a given anomaly detection node in a given decision tree is configured to analyse all of the data instances analysed by the given decision tree in the first training, wherein a subset of at least one data instance is directed to the given end node of the given anomaly detection node, the subset directed to the given end node of the given anomaly detection node is analysed by the root node of the given decision tree. Also in the second training, paths of the at least one data instance through the given decision tree are monitored and the diversion nodes at which the at least one data instance from the subset are diverted from the path to the given end node are identified, and feature values of the diversion nodes are included in a feature contribution of the given anomaly detection node. The ML agent is further operable to process communications network report data using the ensemble algorithm ML model, and detect the presence of anomalous behaviour using the anomaly detection nodes. The ML agent is also operable to identify a base stations exhibiting anomalous behaviour using the feature contribution of the anomaly detection nodes, and generate an alert in response to the identification of a base station exhibiting anomalous behaviour.

The scope of the disclosure is defined by the claims.

### BRIEF DESCRIPTION OF DRAWINGS

The present disclosure is described, by way of example only, with reference to the following figures, in which:—

FIG. 1 is a schematic diagram illustrating a training process for anomaly detection trees;

FIG. 2 is a flowchart of a method in accordance with embodiments;

FIG. 3A is schematic diagram of a ML agent in accordance with embodiments;

FIG. 3B is schematic diagram of a ML agent in accordance with embodiments;

FIG. 3C is a schematic diagram of a computer-readable storage medium in accordance with embodiments;

FIG. 4 is diagram illustrating an example of a second training process used with a plurality of decision trees in accordance with embodiments;

FIG. 5 schematic diagram illustrating an example of how a base station exhibiting anomalous behaviour may be identified using methods in accordance with embodiments; and

FIG. 6A and FIG. 6B are bar charts showing results of analysing the same data instances using a method in accordance with embodiments and several known methods.5

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

Novelty detection algorithms may be well suited to the purpose of detecting anomalous base station behaviour. Novelty detection algorithms may be well suited for this purpose as they may be trained exclusively using benign data (that is, data not indicative of anomalous base station behaviour, or example data that only relates to traffic from normal operations without the presence of false base stations). Allowing training using benign data is useful, as real data (not simulated) that is indicative of anomalous base station behaviour may be difficult to acquire in sufficient quantities for training purposes. A trained algorithm would then be familiar with the properties of normal network data. If the trained algorithm is subsequently presented with data indicative of anomalous base station behaviour, the algorithm should flag this as unfamiliar (novel).

“On Anomaly Interpretation via Shapley Values” by Takeshi, N. and Kawahara, Y., available at https://www.researchgate.net/publication/340541641_On_Anomaly_Interpretation_via_Shapley_Values as of 6 Mar. 2023 discloses the use of a novelty detection algorithm based on Gaussian Mixture Models (GMM); proposals include semi-supervised anomaly detection using a characteristic function, on which the Shapley value is computed, specifically for anomaly scores. The absence of some features may be approximated by minimizing an anomaly score with regard to them.

A further anomaly detection algorithm is discussed in WO 2020/244893 A1; this disclosure relates to a method and an apparatus for training a model for detecting anomalies in network data traffic between devices in a first part of a network and devices in a second part of the network. The method comprises collecting feature samples of network traffic, and training a model based on a plurality of anomaly detection trees collectively forming a random forest model. At least some of the trees comprise subspace selection nodes and anomaly-catching nodes. The subspace selection nodes are arranged to bisect a set of feature samples reaching the subspace selection node to at least one anomaly-catching node when a number of feature samples leaving the subspace selection node for the at least one anomaly-catching node is below a predetermined threshold.

WO 2022/167607 A1 discusses a computer-implemented method and arrangement for classifying anomalies in network traffic, in which feature-associated anomaly scores are determined for network data traffic samples, feature importance for each feature is determined, and the anomalies are classified based on the anomaly scores and feature importance.

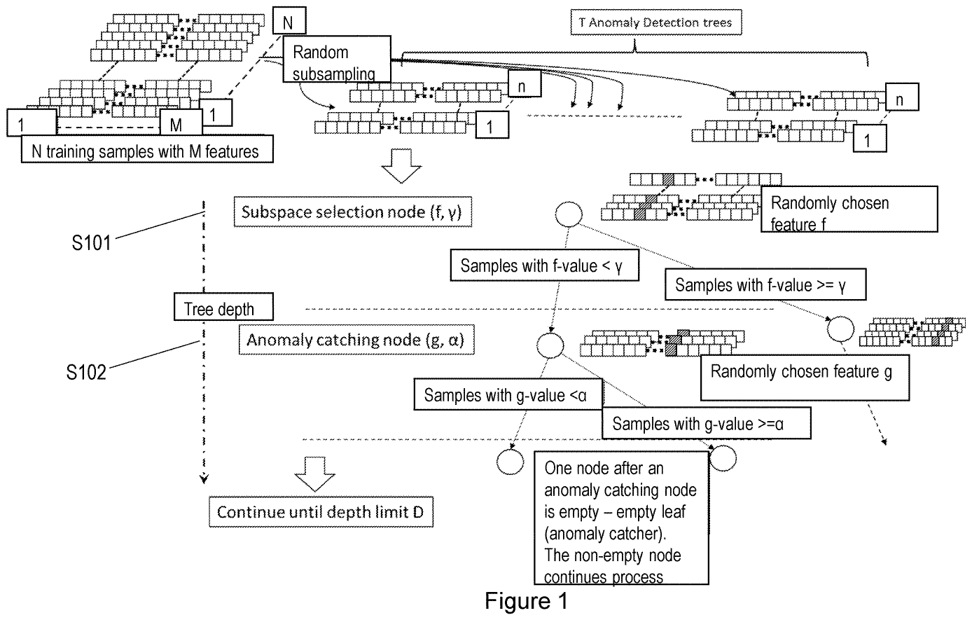

FIG. 1 Is a schematic diagram illustrating a training process for anomaly detection trees in the anomaly detection algorithm discussed in WO 2020/244893 A1 (see above). The anomaly detection trees comprise a root node and a plurality of further nodes arranged in layers (the number of layers may be referred to as the tree depth). Typically, when processing data during training or implementation, the nodes bifurcate received data into one of two connected nodes in a subsequent layer, with the choice of destination node determined based on an analysis of a feature value of the data with respect to a split-value set at the node.

The training of each anomaly detection tree consists of two phases. In both phases each node in each anomaly detection tree selects a feature and a split-value. Typically, the feature is selected at random. During the first phase the feature (f) and split-value (y) are chosen such that the part of the subsample reaching the node during training is split into a right and left subset, as shown at step S101 in FIG. 1, the created nodes are called subspace selection nodes. During the second phase (see step S102), the split-value (a) is instead chosen outside the range of values for the chosen feature (g) in the subsample in that node such that one of the subsets, to the nodes in the subsequent layer, is empty. The nodes without samples in this phase become end nodes and may be referred to as anomaly leaves, with the parent nodes to the leaves referred to as anomaly catchers. Typically data instances indicative of anomalous behaviour should be directed to anomaly leaves at a higher rate than data instances not indicative of anomalous behaviour. An anomaly score for a data sample may then be derived as a function of the length of the paths taken through the anomaly detection trees.

The anomaly detection algorithm discussed in WO 2020/244893 A1 may be used to obtain an indicator of how anomalous communications network report data is, that is, the anomaly detection algorithm may indicate the likely presence or absence of anomalous base station behaviour; this indicator may be referred to as an anomaly detection score. However, an anomaly detection score obtained using the anomaly detection algorithm discussed in WO 2020/244893 A1 does not provide any information regarding the reason for the score.

Where anomalous base station behaviour is suspected (due, for example, to a high anomaly detection score obtained as discussed above), it is desirable to know the specific ID of the base station or base stations causing the suspicions. Accordingly, it is desirable for any high anomaly score to be accompanied by the output of the cell ID(s) (that is, base station ID(s)) found to be most suspicious by the detection algorithm. Known methods that produce outcome explanations for detected anomalies, such as the methods discussed in “On Anomaly Interpretation via Shapley Values” as cited above, are all postprocesses that aim to approximate the anomaly score with feature attributions to produce an outcome explanation; typically these known methods have high computational resource requirements. In many communication networks the number of measurement reports reaching, and generated by, a base station may be large. It is therefore desirable to provide a method and apparatus that performs novelty detection as well as outcome explanation that is more computationally efficient and/or precise than existing systems.

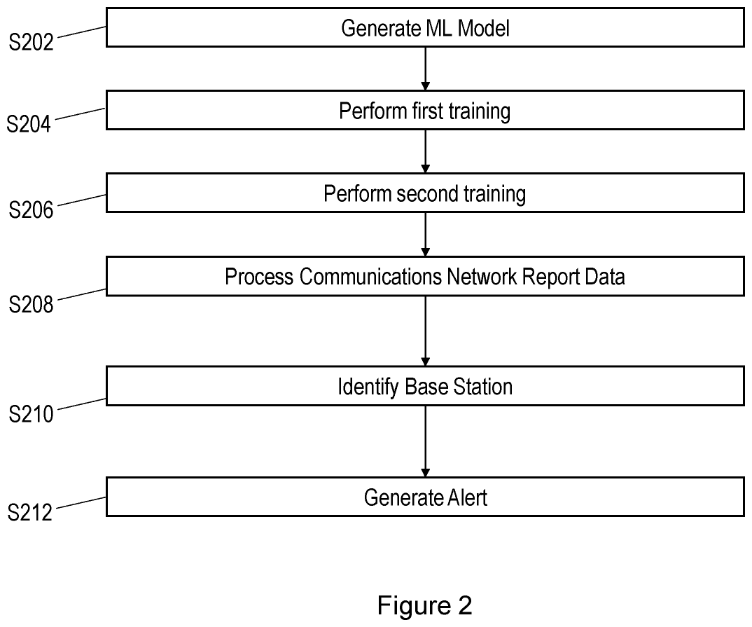

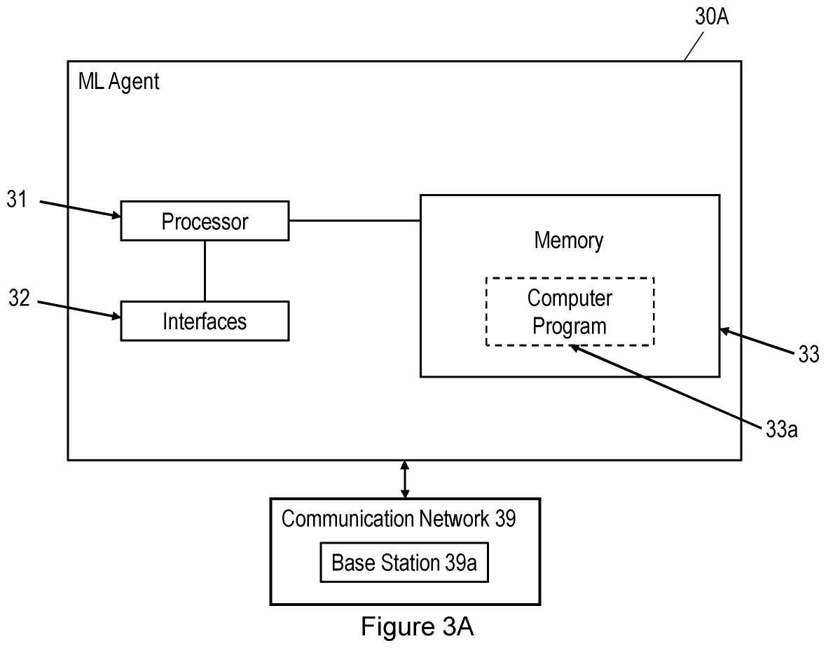

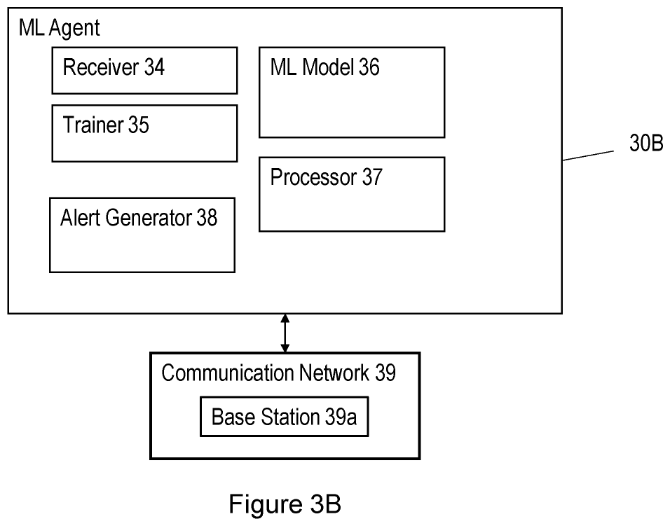

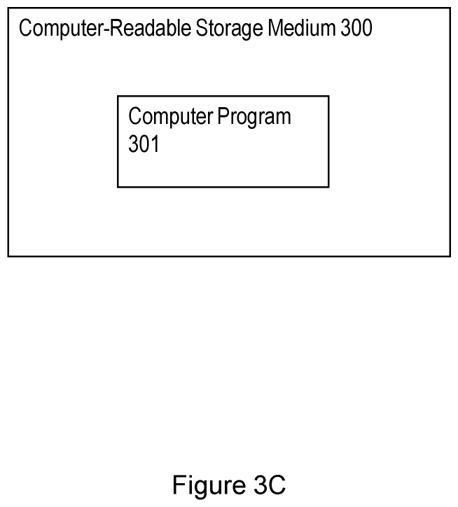

A method in accordance with embodiments is illustrated by FIG. 2, which is a flowchart showing a method for identifying anomalous base station behaviour in a communications network. The method is computer-implemented and may be performed by any suitable apparatus, for example, by a ML agent 30A, 30B such as those shown in FIG. 3A and FIG. 3B. A communication network 39, including a base station 39a, is shown in FIG. 3A and FIG. 3B. Where the communications network is a 5G or 6G telecommunications network or WiFi network (or part of the same), the method may be performed by an apparatus (such as a ML agent) that is or forms part of a network device, such as a base station or CNN (or may be incorporated in a base station or CNN). In some embodiments, the ML agent may be or form part of a further device that is separate from the communications network.

In FIG. 3A and FIG. 3B, for simplicity, the communication network 39 and base station 39a are shown separately from the ML agent 30.

As shown in step S202 of FIG. 2, the method comprises generating an ensemble algorithm ML model comprising a plurality of decision trees. The ensemble algorithm may be a random forest algorithm, specifically an anomaly detection forest (ADF), or any other suitable ML algorithm such as an isolation forest or one-class random forest. The step of generating the ensemble algorithm ML model may be performed in accordance with a computer program (33a) stored in a memory 33 (or a computer program 301 stored in a computer-readable storage medium 300 as illustrated by FIG. 3C), executed by a processor 31 in conjunction with one or more interfaces 32 of ML agent 30A, as illustrated by FIG. 3A. Alternatively, the step of generating the ensemble algorithm ML model may be performed by processor 37 of ML agent 30B, as shown in FIG. 3B, and may result in ML model 36. In some embodiments the ensemble algorithm may be a random forest. Each of the decision trees comprises a root node and a plurality of levels of nodes, each node in a given level being connected to a maximum of two child nodes in a subsequent level. One or more of the decision trees may comprise only two levels of nodes, that is, a root node and one further level of nodes. Typically, however, the decision trees comprise plural levels of nodes subsequent to the root node.

Following the generation of the ML model, the method then continues with the training of each of the plurality of decision trees in a first training stage using a plurality of data instances, as shown in step S204 of FIG. 2. The step of training the plurality of decision trees in a first training stage may be performed in accordance with a computer program (33a) stored in a memory 33 (or a computer program 301 stored in a computer-readable storage medium 300 as illustrated by FIG. 3C), executed by a processor 31 in conjunction with one or more interfaces 32 of ML agent 30A, as illustrated by FIG. 3A. Alternatively, the step of training the plurality of decision trees in a first training stage may be performed by trainer 35 of ML agent 30B, as shown in FIG. 3B. Before training, the initialisation parameters of the plurality of decision trees may be set to generic values so that the decision trees do not initially favour any particular action or actions over other actions.

The plurality of data instances used in the first training (which may be the same as the data used in the second training, or different data, as discussed below), may be obtained from a communications network report data set. Typically the data instances are divided between the plurality of decision trees, such that different decision trees process different data. The selection of data instances for each decision tree from the communications network report data set may be made in any suitable way, as an example, a random selection method may be used or the data instances may be allocated sequentially until all data instances in the communications network report data set have been allocated to a decision tree.

The communications network report data set may comprise data from a real-world communication network and/or may comprise data from a simulated communication network. Any suitable communications network report data may be included and used; by way of example, in some embodiments the communications network report data comprises Radio Resource Control (RRC) measurements. The RRC measurements may comprise one or more of: Reference Signal Receive Power (RSRP) measurements; Reference Signal Receive Quality (RSRQ) measurements; Received Signal Strength Indicator (RSSI) measurements; Signal to Interference and Noise Ratio (SINR) measurements; UE positioning measurements; and so on. In some embodiments, the plurality of data instances used to perform the first training may be filtered to exclude data instances indicative of anomalous behaviour; typically data instances that are outliers in the communications network report data set are excluded in a filtering process. The filtering may be done using any suitable filtering method (which may be an outlier detection method). By way of example, excluding data instances having a feature values lying more than a certain number of standard deviations (such as 2 or 3) from a mean feature value for the plurality of data instances, or having a human expert manually review all data instances and exclude those indicative of anomalous behaviour, may form all or part of the filtering.

As a result of the first training, a first portion of the nodes in each decision tree act as selection nodes that direct a portion of received data instances to each of two child nodes (in a subsequent layer), based on analysis of the feature values of the received data instances, and a second portion of the nodes in each decision tree act as anomaly detection nodes that direct a majority of the received data instances to one of two child nodes, based on analysis of the feature values of the received data instances, where the child node that receives a minority of the received data instances acts as an end node. In some embodiments, the majority of the received data instances comprise all of the received data instances, and the minority of received data instances comprises none of the received data instances. In some embodiments, the first training comprises a first phase and a second phase. The two phases may be configured such that, in a first phase, a feature and a split value for the feature for each node of the given decision tree are selected, the split value for each node being selected to be within the range of feature values from the data instances that are processed by the node in the first training. A subset of data instances is then processed using the given decision tree. Subsequently, in a second phase a revised split value is selected for the feature for each node of the given decision tree, the revised split value being selected to be outside the range of data feature values from the data instances that are processed by the node in the first training, thereby resulting in the majority of received data instances being directed to one of the two child nodes. In some embodiments the first training may be similar or the same as the training process discussed above with reference to FIG. 1.

Subsequent to the first training, the method then continues with the step of second training for each of the plurality of decision trees, as shown in as shown in step S206 of FIG. 2. The step of training the plurality of decision trees in a second training stage may be performed in accordance with a computer program (33a) stored in a memory 33 (or a computer program 301 stored in a computer-readable storage medium 300 as illustrated by FIG. 3C), executed by a processor 31 in conjunction with one or more interfaces 32 of ML agent 30A, as illustrated by FIG. 3A. Alternatively, the step of training the plurality of decision trees in a second training stage may be performed by trainer 35 of ML agent 30B, as shown in FIG. 3B.

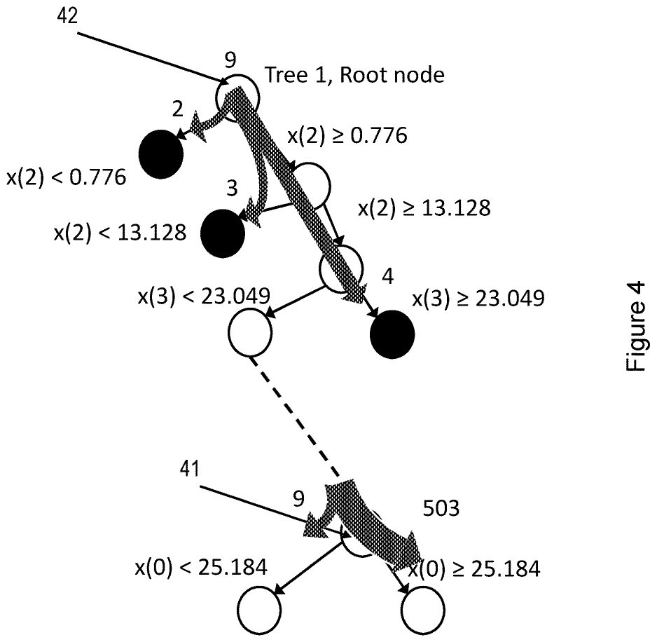

In the second training of the plurality of decision trees, all of the data instances analysed in the first training by a given decision tree from the plurality of decision trees are passed to a given anomaly detection node in that given decision tree. That is, the given anomaly detection node is used to analyse all of the data instances that were originally passed to the root node of the given decision tree, instead of only those that pass from the root node through the decision tree to the given anomaly detection node. A subset of the data instances is then typically directed to the anomaly detection node; where this does not happen the second training of the given anomaly detection node ends. FIG. 4 is a diagram illustrating an example of the second training process used with the plurality of decision trees. In the example shown in FIG. 4, there are 512 data instances analysed in the first training; as discussed above all 512 of these data instances are analysed in the second training by an anomaly detection node 41. The anomaly detection node analyses feature f₀ with a split value of 25.184; where the data instance has a value for f₀ that is less than this split value (x(0)<25.814) it is directed to an end node, whereas when the data instance has a value for f₀ that is greater than or equal to this split value (x(0)>25.814) it is directed to a further node (not shown in FIG. 4). The analysis of the 512 data instances by the anomaly detection node 41 results in nine of the data instances being directed to the anomaly detection node; these nine data instances form the subset of data instances for the given anomaly detection node.

The subset of at least one data instance for the given anomaly detection node is then analysed by the root node 42 of the given decision tree, and the path(s) of the data instance(s) through the given decision tree are monitored, such that the diversion nodes at which the at least one data instance from the subset is/are diverted from the path to the given end node may be identified. In the FIG. 4 example, the root node 42 analyses feature f₂ of the nine data instances with a split value of 0.776; where the data instance has a value for f₂ that is less than this split value (x(2)<0.776) it is directed to an end node, whereas when the data instance has a value for f₂ that is greater than or equal to this split value (x(2)>0.776) it is directed to a further node. In the example shown in FIG. 4 the root node acts as an anomaly detection node; in some embodiments this is not the case. Typically, the decision trees include some nodes that act as anomaly detection nodes and some nodes that do not act as anomaly detection nodes. The result of the analysis at root node 42 is that two of the nine data instances are directed to the end node; this is because these two data instances each have a value for f₂ that is less than this split value (x(2)<0.776). The remaining seven data instances are then analysed at the next node, and so on. In the FIG. 4 example, three of the data instances are directed to an end node following analysis of feature f₂ again (with a different split value; the feature values at the nodes are selected at random and some duplication is likely) and the remaining four data instances are directed to an end node following analysis of feature f₃, as shown in the figure.

The paths of the at least one data instance through the given decision tree are monitored and the diversion nodes at which the at least one data instance from the subset are diverted from the path to the given end node are identified (for example, two of the data instances are diverted from the path to the given end node at root node 42, as discussed above). Feature values of the identified division nodes are then included in a feature contribution of the given anomaly detection node. The second training process is then repeated for each decision tree, typically for each anomaly detection node in each decision tree. The result of the second training process is that each anomaly detection node includes the feature values of the division nodes, as discussed above.

The feature values of the division nodes may be incorporated into the anomaly detection nodes in any suitable way. In some embodiments, for each end node in each tree t, a 1 is written to the feature f, of the immediate parent node (that is, the anomaly detection node as discussed previously). The share of the training subsample X^{t}, for tree t, that would have ended up in the end node if not for the previous path, i.e.

$${X}_{l}^{t} = \{ x ∈ {X}^{t} , x ( f ) < s \}$$

if the end node is a left child of the parent and

$${X}_{l}^{t} = \{ x ∈ {X}^{t} , x ( f ) \geq s \}$$

otherwise. The set

$${X}_{l}^{t}$$

is then passed from the root node through the tree t as discussed above on the path to the end node. For every node with feature fₙ and split value sₙ such that some samples in Xₗ deviate from the path to the end node, 1 is added to the feature fₙ in the contributing features since the end node would otherwise not have been created (that is, the end node would not be empty). In some embodiments the split value s in the parent may be such that the set

$${X}_{l}^{t}$$

may be empty from the start, in which case only one feature will be seen as contributing.

In some embodiments, the feature f in the anomaly catcher node directly above the anomaly leaf can be given the score 2, while other features will be given 1 or 0.

Continuing with the FIG. 4 example, the following table indicates the results of the second training process (note that in this example the given anomaly detection node is node 11, with the given end node 12). The results are presented in the following structure; Depth: (feature_idx, split_value, child is left or right, reduced samples), where “reduced samples” is the number of data instances diverted from the path as discussed above.

====== Nodes in path to Leaf 1 (given end node 12), Tree 1

Root: (2, 0.7764543394210393, ‘right’, 2)

1: (2, 13.128346652600715, ‘right’, 3)

2: (3, 23.049082485573, ‘left’, 4)

3: (4, 8.324989209153932, ‘right’, 0)

4: (0, 39.235375676756796, ‘left’, 0)

5: (1, 1.7660593909918103, ‘right’, 0)

6: (7, 7.042021283054597, ‘left’, 0)

7: (1, 6.055221001119222, ‘left’, 0)

8: (2, 34.54080665347748, ‘left’, 0)

9: (3, 2.6225027509101126, ‘right’, 0)

10: (7, 3.544165749251146, ‘left’, 0)

11: (0, 25.184442013082588, ‘left’, 503)

The Features scores for this given anomaly detection node, using the example method discussed above where the results are in the format (feature id:feature score), are therefore (0:1, 2:1; 2:1; 3:1), that is, each of features 2, 2 again (each feature is only counted once, so repeat instances such as this are discarded) and 3 (analysed by the root node and nodes in the next two layers respectively, as shown in FIG. 4) have a feature score of 1, and feature 0 also has a score of 1 from the analysis at the anomaly detection node 11.

The FIG. 4 example includes three decision trees (labelled Tree 1, Tree 2 and Tree 3; FIG. 4 shows a portion of Tree 1). Embodiments may include greater, smaller or the same number of decision trees; typically embodiments include more than three decision trees. Example results for the second training process when applied to Tree 2 and Tree 3 of the example illustrated by FIG. 4 shown below. In Tree 2, the given anomaly detection node is node 5, and in Tree 3 the given anomaly detection node is node 7. In the FIG. 4 example, each of the trees was trained using 512 data instances; in some embodiments trees may be trained with equal or different numbers of data instances:
====== Nodes in path to given end node 6, Tree 2
Root: (5, 15.12289200466605, ‘left’,101)
1: (1, 1.5323262162566746, ‘right’,122)
2: (4, 19.779874230215736, ‘left’,35)
3: (2, 7.622629327353716, ‘right’,22)
4: (6, 43.046715064867094, ‘left’,0)
5: (3, 12.611269423913292, ‘left’,232)

The feature scores for this given anomaly detection node, using the example method discussed above where the results are in the format (feature id:feature score), are therefore (3:1, 5:1, 1:1. 4:1, 2:1), that is, each of features 5, 1, 4 and 2 (analysed by the root node and nodes in the next three layers respectively) have a feature score of 1, and feature 3 also has a score of 1 from the analysis at the anomaly detection node.

The equivalent information for Tree 3 is as follows:
====== Nodes in path to given end node 8, Tree 3
Root: (3, 0.3431300041880109, ‘right’,283)
1: (1, 3.336806116728447, ‘right’, 0)
2: (2, 34.76731338474069, ‘left’, 0)
3: (1, 3.912029401991947, ‘right’, 0)
4: (4, 33.06261017694369, ‘left’, 0)
5: (1, 6.558834125623603, ‘left’,0)
6: (2, 32.54806969110105, ‘left’, 0)
7: (3, 7.022816178525241, ‘left’, 229)

In Tree 3, 283 of the 512 data instances would have ended up in the given end node without the previous path; this shows an example where 2 may be written as the feature score for one feature. The feature score for this given anomaly detection node is (3:2).

Following the second training of each of the decision trees, the method then continues with processing of communications network report data using the ensemble algorithm ML model, and detecting the presence of anomalous behaviour using the anomaly detection nodes; this step is shown in step S208 of FIG. 2. The step of processing the communications network report data may be performed in accordance with a computer program (33a) stored in a memory 33 (or a computer program 301 stored in a computer-readable storage medium 300 as illustrated by FIG. 3C), executed by a processor 31 in conjunction with one or more interfaces 32 of ML agent 30A, as illustrated by FIG. 3A. Alternatively, the step of processing the communications network report data may be performed by processor 37 and ML model 36 of ML agent 30B, as shown in FIG. 3B. The communications network report data may be provided to the ML agent 30 in any suitable way, for example, via a transmission from other network components received by the ML agent 30 or through monitoring by the ML agent 30. In some embodiments the composition of the communications network report data may be the same as or similar to that of the communications network report data set used in one or both of the first training and second training; where the communications network report data is similar to the communications network report data set, this may increase the efficacy of the first and/or second training. By way of example, the communications network report data may comprise RRC measurements, which may include one or more of RSRP, RSRQ, RSSI, SINR and/or UE positioning measurements. The processing allows the detection of the presence of anomalous behaviour using the anomaly detection nodes. In the processing of the communications network report data, the data instances from the communications report data may be analysed by a decision tree from the ensemble algorithm ML model. In some embodiments, one or more (optionally all) of the data instances from the communications report data may be analysed plural times using plural different decision trees from the ensemble algorithm ML model. In some embodiments the maximal analysis option, wherein each of the data instances from the communications report data may be analysed using all of the different decision trees from the ensemble algorithm ML model, may be used. Analysing the data instances using plural decision trees may further improve the accuracy of results obtained; in some embodiments each decision tree individually may be a weak indicator of the identity of a base station (or base stations) exhibiting anomalous behaviour, but collectively a plurality of decision trees may act as a strong indicator.

Where anomalous behaviour is detected, the method then continues with the step of identifying a base station 39a (or base stations) exhibiting the anomalous behaviour, as shown in step S210 of FIG. 2. The step of identifying a base station (or base stations) exhibiting anomalous behaviour may be performed in accordance with a computer program (33a) stored in a memory 33 (or a computer program 301 stored in a computer-readable storage medium 300 as illustrated by FIG. 3C), executed by a processor 31 in conjunction with one or more interfaces 32 of ML agent 30A, as illustrated by FIG. 3A. Alternatively, the step of identifying a base station (or base stations) exhibiting anomalous behaviour may be performed by processor 37 and ML model 36 of ML agent 30B, as shown in FIG. 3B. The identification may be performed by analysing the feature contribution of the anomaly detection nodes. In some embodiments, the processing of the communications network report data (see step S208) comprises generating an anomaly score for each base station; in embodiments that generate an anomaly score in this way, the anomaly score may be used to identify base station(s) 39a exhibiting anomalous behaviour. By way of example, in some embodiments an anomaly score above a predetermined threshold, or an anomaly score that differs from the anomaly scores of other base stations in the network by a predetermined degree (such as being a given number of standard deviations from the mean score) may be the basis upon which base stations exhibiting anomalous behaviour are identified.

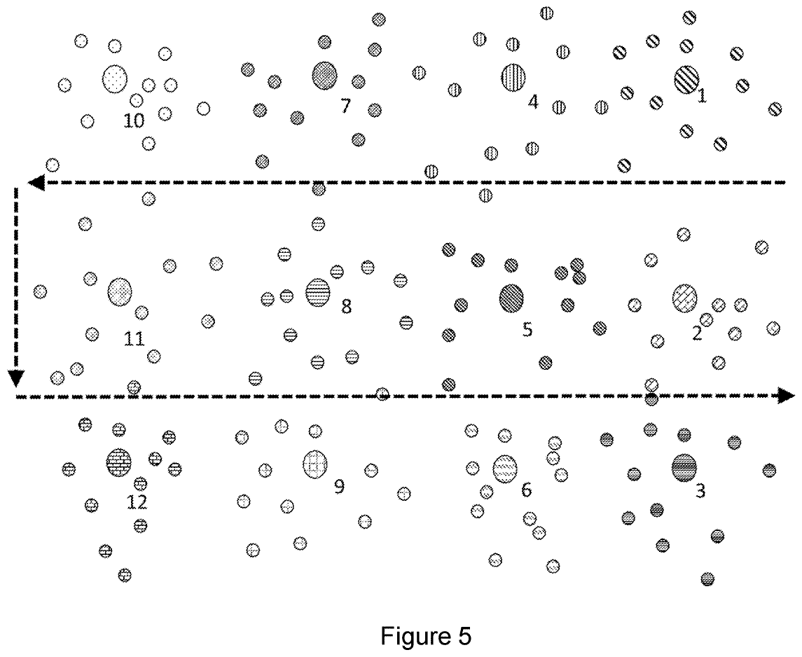

FIG. 5 is a schematic diagram illustrating an example of how a base station exhibiting anomalous behaviour may be identified. In the FIG. 5 example a simulated environment comprising 12 base stations is shown. The base stations are numbered 1 to 12 and are indicated by the larger ovals in the figure. The UEs are indicated by the smaller ovals and use the same shading pattern as the base station to which they are connected, for example, base station 4 and the UEs connected to base station 4 all use a vertical stripe shading pattern. One or more of the base stations hosts an ensemble algorithm ML model in accordance with embodiments that may be used to detect deviations in measurement reports sent to the base station from the UEs connected to it, said deviations being indicative of anomalous base station behaviour. In this example, base station 3 exhibits anomalous behaviour, specifically, base station 3 is a false base station which moves around the environment as indicated by the dashed arrows on the figure. Base station 6 uses the ensemble algorithm ML model to process communications report data.

Base station 6 has 6 different (visible) base stations, specifically base stations [2, 3, 5, 8, 9, 12] that appear in the RRC measurement reports received from UEs connected to it. The UE measurement reports act as data instances in the communications report data, in this example the data instances are in the form of a feature vector with the signal strength (RSRP) of the serving base station (that is, base station 6), the number of neighbouring base stations the UE can receive signals from (NNei, that is, visible base stations) and the signal strength of each of the visible neighbouring base stations (RSRP_{id}). In some implementations the data instances may contain further data, however analysis of RSRP alone is used have for simplicity in explaining the operation of embodiments. Table 1 below shows four example data instances from a UE connected to base station 6; instances 0, 1 and 2 are indicative of normal behaviour and instance 3 is indicative of abnormal behaviour (in this example, base station 3 has changed position, causing a variation in the RSRP value for this base station).

TABLE 1

| | RSRP | NNei | RSRP2 | RSRP3 | RSRP5 | RSRP8 | RSRP9 | RSRP12 |
|---|---|---|---|---|---|---|---|---|
| 0 | 25.0 | 4 | 0.0 | 12.0 | 12.0 | 12.0 | 23.0 | 0.0 |
| 1 | 26.0 | 4 | 12.0 | 24.0 | 12.0 | 0.0 | 12.0 | 0.0 |
| 2 | 30.0 | 4 | 17.0 | 17.0 | 29.0 | 0.0 | 17.0 | 0.0 |
| 3 | 20.0 | 4 | 14.0 | 6.0 | 11.0 | 0.0 | 9.0 | 0.0 |

Analysis of the above results using embodiments and existing systems demonstrates the increased effectiveness of the embodiments. By way of example, if the methods discussed in WO 2022/167607 A1 are applied to the Table 1 data, the data instances [0, 1, 2, 3] (where 3 is indicative of abnormal behaviour) yield anomaly scores of [0.51, 0.48, 0.5, 0.66]. Applying a method in accordance with embodiments results in anomaly scores of [0.22, 0.03, 0.15, 0.8]; the difference in anomaly score for the abnormal data instance is significantly larger for the embodiment method when compared to the existing system. Also, for the anomalous instance, existing method indicates [RSRP] in general as the explanation for the high score (0.66) whereas the embodiment method gives the correct explanation [nRSRP_3] corresponding to the score (0.8), that is, specifically the RSRP from base station 3.

The anomaly score of 0.8 obtained using the embodiment method may be obtained by including feature values of the diversion nodes in the feature contributions for anomaly detection nodes, as discussed above. Analysing the Table 1 data instance 3 [20.0, 4.0, 14.0, 6.0, 11.0, 0.0, 9.0, 0.0] using Trees 1 to 3 as discussed above results in the following feature scores:
Tree 1: {0:1, 2:1, 3:1}
Tree 2: {1:1, 2:1, 3:1, 4:1, 5:1}
Tree 3: {3:2}

The total feature contributions from Tree 1, Tree 2 and Tree 3 are therefore {0:1, 1:1, 2:2, 3:4, 4:1, 5:1}. When the data is filtered by all of the trees, the feature contribution is [50, 34, 42, 85, 44, 29, 53, 0] which normalized becomes [0.14836795, 0.10089021, 0.12462908, 0.25222552, 0.1305638, 0.08605341, 0.15727003, 0]. The normalised feature contribution indicates that it is feature 3 (with a value of 0.25222552) that is responsible for the high score; this corresponds to nRSRP_3 (signal power from base station with ID 3). The score of 0.8 implies that the data instance ends up in an anomaly leaf in 80% of the trees.

Continuing with the flowchart of FIG. 2, when one or more base stations 39a exhibiting anomalous behaviour have been identified using the feature contribution of the anomaly detection nodes, an alert is then generated in response to the identification (as shown instep S212 of FIG. 2). The step of generating the alert may be performed in accordance with a computer program (33a) stored in a memory 33 (or a computer program 301 stored in a computer-readable storage medium 300 as illustrated by FIG. 3C), executed by a processor 31 in conjunction with one or more interfaces 32 of ML agent 30A, as illustrated by FIG. 3A. Alternatively, the step of generating the alert may be performed by alert generator 38 of ML agent 30B, as shown in FIG. 3B. As mentioned previously, the identification of base stations exhibiting anomalous behaviour is based on analysis of the generated anomaly score for each base station, and the alert may be generated when the anomaly score exceeds a (typically system specific) predetermined threshold. In some embodiments, the generation of the alert may comprise triggering an audible alarm, for example, in a network control centre. The alert may additionally or alternatively comprise transmitting an alert signal to a network control centre, network operator, and so on; this signal may comprise identification information for the base station or base stations exhibiting anomalous behaviour. The information may then be used to address the anomalous behaviour; this may comprise redirecting network traffic away from the base station and/or shifting UEs away from the base station. Further where the anomalous behaviour is caused by a faulty base station this may comprise repairing or replacing the faulty base station, and where the anomalous behaviour is caused by a false base station this may comprise permanently excluding the base station from the network (by blocking traffic to/from the base station) and/or informing law enforcement if applicable.

Embodiments may support identification of anomalous behaviour and identification of base station(s) responsible for the same with increased efficiency and/or accuracy relative to existing systems. Embodiments may provide a higher anomaly recall at a fixed false positive rate and a better explanation accuracy for determining the correct base station(s) (exhibiting anomalous behaviour) than existing systems. Also, in some embodiments an anomaly score may be obtained in the same process as an explanation of the score with no extra processing required.

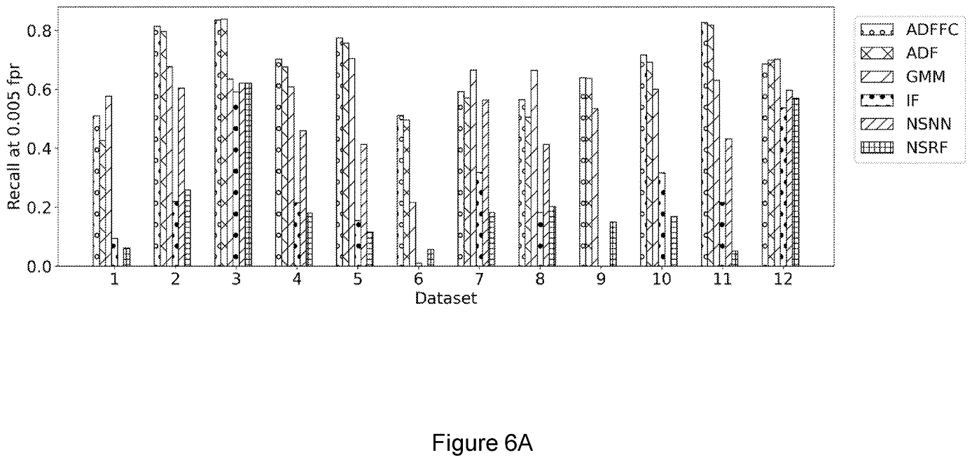

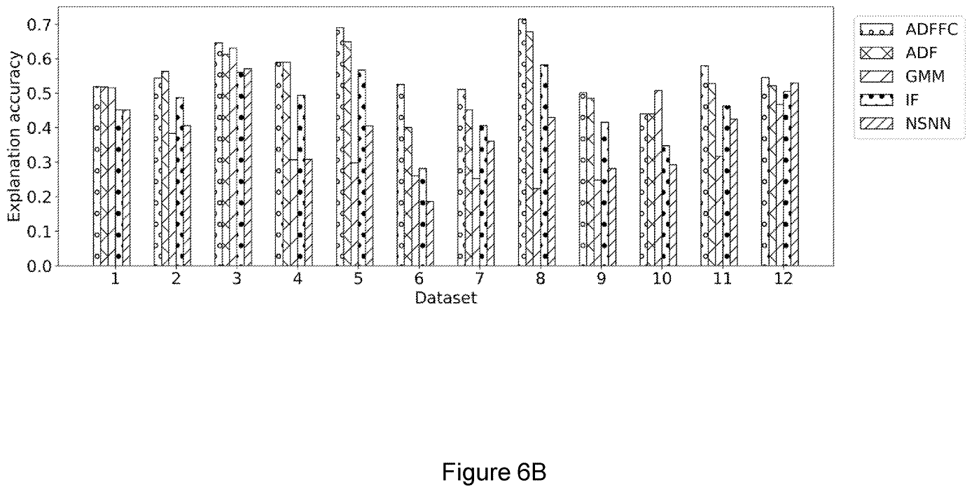

FIG. 6A and FIG. 6B are bar charts showing results of analysing the same data instances using a method in accordance with embodiments (referred to in the figures as ADFFC) and several known methods. The known methods are: an ADF algorithm not including the second training process as discussed above (referred to in the figures as ADF); a GMM using a Shapley based outcome explanation method from “On Anomaly Interpretation via Shapley Values” as cited above (referred to in the figures as GMMSHAP); an isolation forest using a depth-based isolation forest feature importance outcome explanation method (referred to in the figures as LDIFFI); and a negative sampling neural network using integrated gradient base outcome explanation (referred to in the figures as NSNNIG). FIG. 6A shows the recall of records for base stations exhibiting anomalous behaviour records for a fixed false positive rate of 0.5%, and FIG. 6B shows outcome explanation accuracy results for all records containing a base station exhibiting anomalous behaviour, taken as the quota of correctly identified base stations exhibiting anomalous behaviour divided by number of records with a base station exhibiting anomalous behaviour. As shown in FIG. 6, the performance of the method in accordance with embodiments provides superior results to existing methods in both analyses.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program (33a, 301), and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some embodiments may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A method for identifying anomalous base station behaviour in a communications network, the method comprising:
generating an ensemble algorithm machine learning, ML, model comprising a plurality of decision trees, each of the decision trees comprising a root node and a plurality of levels of nodes, each node in a given level being connected to a maximum of two child nodes in a subsequent level;
performing first training of each of the plurality of decision trees using a plurality of data instances, such that:
a first portion of the nodes in each decision tree act as selection nodes that direct a portion of received data instances to each of two child nodes, based on analysis of the feature values of the received data instances; and
a second portion of the nodes in each decision tree act as anomaly detection nodes that direct a majority of the received data instances to one of two child nodes, based on analysis of the feature values of the received data instances, where the child node that receives a minority of the received data instances acts as an end node;
performing second training of each of the plurality of decision trees in which:
a given anomaly detection node in a given decision tree analyses all of the data instances analysed by the given decision tree in the first training, a subset of at least one data instance being directed to the given end node of the given anomaly detection node;
the subset directed to the given end node of the given anomaly detection node is analysed by the root node of the given decision tree;
paths of the at least one data instance through the given decision tree are monitored and the diversion nodes at which the at least one data instance from the subset are diverted from the path to the given end node are identified; and
feature values of the diversion nodes are included in a feature contribution of the given anomaly detection node;
processing communications network report data using the ensemble algorithm ML model, and detecting the presence of anomalous behaviour using the anomaly detection nodes;
identifying a base station exhibiting anomalous behaviour using the feature contribution of the anomaly detection nodes; and
generating an alert in response to the identification of a base station exhibiting anomalous behaviour.

2. The method of claim 1, wherein each of the plurality of decision trees is trained with a subset of data instances from a communications network report data set.

3. The method of claim 2, wherein the subset of data instances used to train each of the plurality of decision trees is selected randomly.

4. The method of claim 2, wherein the first training for the given decision tree from among the plurality of decision trees comprises:
in a first phase, selecting a feature and a split value for the feature for each node of the given decision tree, the split value for each node being selected to be within the range of feature values from the data instances that are processed by the node in the first training, and processing the subset of data instances using the given decision tree; and
in a second phase, selecting a revised split value for the feature for each node of the given decision tree, the revised split value being selected to be outside the range of data feature values from the data instances that are processed by the node in the first training.

5. The method of claim 1, wherein for the anomaly detection nodes, the majority of the received data instances comprises all of the received data instances, and the minority of received data instances comprises none of the received data instances.

6. The method of claim 1, wherein the communications network report data comprises Radio Resource Control, RRC, measurements.

7. The method of claim 6, wherein the RRC measurements comprise one or more of: Reference Signal Receive Power, RSRP, measurements; Reference Signal Receive Quality, RSRQ, measurements; Received Signal Strength Indicator, RSSI, measurements; Signal to Interference and Noise Ratio, SINR, measurements; and User Equipment, UE, positioning measurements.

8. The method of claim 1, wherein the processing of communications network report data comprises generating an anomaly score for each base station.

9. The method of claim 8, wherein the identification of base stations exhibiting anomalous behaviour is based on analysis of the generated anomaly score for each base station.

10.-21. (canceled)

22. A machine learning, ML, agent configured to host a ML model, the ML agent comprising processing circuitry and a memory containing instructions executable by the processing circuitry, whereby the ML agent is operable to:
generate an ensemble algorithm ML model comprising a plurality of decision trees, each of the decision trees comprising a root node and a plurality of levels of nodes, each node in a given level being connected to a maximum of two child nodes in a subsequent level;
perform first training of each of the plurality of decision trees using a plurality of data instances such that:
a first portion of the nodes in each decision tree act as selection nodes that are configured to direct a portion of received data instances to each of two child nodes, based on analysis of the feature values of the received data instances; and
a second portion of the nodes in each decision tree act as anomaly detection nodes that are configured to direct a majority of the received data instances to one of two child nodes, based on analysis of the feature values of the received data instances, where the child node that receives a minority of the received data instances is configured to act as an end node;
perform second training of each of the plurality of decision trees in which:
a given anomaly detection node in a given decision tree is configured to analyse all of the data instances analysed by the given decision tree in the first training, a subset of at least one data instance being directed to the given end node of the given anomaly detection node;
the subset directed to the given end node of the given anomaly detection node is analysed by the root node of the given decision tree;
paths of the at least one data instance through the given decision tree are monitored and the diversion nodes at which the at least one data instance from the subset are diverted from the path to the given end node are identified; and
feature values of the diversion nodes are included in a feature contribution of the given anomaly detection node;
process communications network report data using the ensemble algorithm ML model, and detect the presence of anomalous behaviour using the anomaly detection nodes;
identify a base station exhibiting anomalous behaviour using the feature contribution of the anomaly detection nodes; and
generate an alert in response to the identification of a base station exhibiting anomalous behaviour.

23. The ML agent of claim 22, configured to train each of the plurality of decision trees with a subset of data instances from a communications network report data set.

24. The ML agent of claim 23, wherein the subset of data instances used to train each of the plurality of decision trees is selected randomly.

25. The ML agent of claim 23 configured, in the first training for the given decision tree from among the plurality of decision trees to:
in a first phase, select a feature and a split value for the feature for each node of the given decision tree, the split value for each node being selected to be within the range of feature values from the data instances that are processed by the node in the first training, and processing the subset of data instances using the given decision tree; and
in a second phase, select a revised split value for the feature for each node of the given decision tree, the revised split value being selected to be outside the range of data feature values from the data instances that are processed by the node in the first training.

26. The ML agent of claim 22 wherein, for the anomaly detection nodes, the majority of the received data instances comprises all of the received data instances, and the minority of received data instances comprises none of the received data instances.

27. The ML agent of claim 22, wherein the communications network report data comprises Radio Resource Control, RRC, measurements.

28. The ML agent of claim 27, wherein the RRC measurements comprise one or more of: Reference Signal Receive Power, RSRP, measurements;
Reference Signal Receive Quality, RSRQ, measurements; Received Signal Strength Indicator, RSSI, measurements; Signal to Interference and Noise Ratio, SINR, measurements; and User Equipment, UE, positioning measurements.

29. The ML agent of claim 22 configured, when processing the communications network report data, to generate an anomaly score for each base station.

30. The ML agent of claim 29, wherein the identification of base stations exhibiting anomalous behaviour is based on analysis of the generated anomaly score for each base station.

31.-41. (canceled)

42. The ML agent of claim 22, wherein the ML agent is comprised in a communications network along with one or more base stations.

43. (canceled)

44. A computer-readable storage medium having stored thereon a computer program comprising instructions which, when executed on at least one processor, cause the at least one processor to carry out a method for identifying anomalous base station behaviour in a communications network, the method comprising:
generating an ensemble algorithm machine learning, ML, model comprising a plurality of decision trees, each of the decision trees comprising a root node and a plurality of levels of nodes, each node in a given level being connected to a maximum of two child nodes in a subsequent level;
performing first training of each of the plurality of decision trees using a plurality of data instances such that:
a first portion of the nodes in each decision tree act as selection nodes that direct a portion of received data instances to each of two child nodes, based on analysis of the feature values of the received data instances; and
a second portion of the nodes in each decision tree act as anomaly detection nodes that direct a majority of the received data instances to one of two child nodes, based on analysis of the feature values of the received data instances, where the child node that receives a minority of the received data instances acts as an end node;
performing second training of each of the plurality of decision trees in which:
a given anomaly detection node in a given decision tree analyses all of the data instances analysed by the given decision tree in the first training, a subset of at least one data instance being directed to the given end node of the given anomaly detection node;
the subset directed to the given end node of the given anomaly detection node is analysed by the root node of the given decision tree;
paths of the at least one data instance through the given decision tree are monitored and the diversion nodes at which the at least one data instance from the subset are diverted from the path to the given end node are identified; and
feature values of the diversion nodes are included in a feature contribution of the given anomaly detection node;
processing communications network report data using the ensemble algorithm ML model, and detecting the presence of anomalous behaviour using the anomaly detection nodes;
identifying a base station exhibiting anomalous behaviour using the feature contribution of the anomaly detection nodes; and
generating an alert in response to the identification of a base station exhibiting anomalous behaviour.
